(19) United States
(12) Patent Application Publication
(10) Pub. No.: US 2026/0049220 A1
(43) Pub. Date: Feb. 19, 2026

(54) COATED OIL OR GAS OPERATION COMPONENTS THAT DEMONSTRATE REDUCED FOULING AND METHODS OF INHIBITING FOULING OF AN OIL OR GAS OPERATION COMPONENT

(71) Applicant: ACULON, INC., SAN DIEGO, CA (US)

(72) Inventors: Eric L. Hanson, Carlsbad, CA (US); Eric L. Bruner, La Jolla, CA (US); Majid Monji, San Diego, CA (US); Qian HE, San Diego, CA (US)

(21) Appl. No.: 19/302,517

(22) Filed: Aug. 18, 2025

Related U.S. Application Data
(60) Provisional application No. 63/683,871, filed on Aug. 16, 2024.

(51) Int. Cl. C09D 5/16; E21B 37/06

(52) U.S. Cl. CPC C09D 5/1662; E21B 37/06

(57) ABSTRACT

Coated oil or gas operation components include:
(a) a substrate with a surface having reactive functional groups;
(b) a polymerization initiator chemically bonded to at least one surface of the substrate via reaction with the reactive functional groups on the surface of the substrate; and
(c) a polymeric coating layer that demonstrates hydrophilicity. The polymeric coating layer is prepared by a radical polymerization process from a monomer composition comprising at least one free radical polymerizable monomer having at least one hydrophilic functional group, such as a (meth)acrylamide group. The polymeric coating layer is chemically bonded to and propagated from the polymerization initiator. Also provided are methods of inhibiting fouling of an oil or gas operation component by an organic or inorganic contaminant.

### CROSS-REFERENCE TO RELATED APPLICATIONS

The present application claims the benefit of U.S. Provisional Patent Application Ser. No. 63/683,871, titled “Coated Oil or Gas Operation Components that Demonstrate Reduced Fouling and Methods of Inhibiting Fouling of an Oil or Gas Operation Component”, filed Aug. 16, 2024, and incorporated by reference in its entirety.

The present application is related to International Patent Application Number PCT/US2022/049827, titled “Coated Substrates that Demonstrate Superhydrophilicity, Suitable for use as Medical Devices”, filed Nov. 14, 2022, which claims the benefit of U.S. Provisional Patent Application Ser. No. 63/281,016, titled “Coated Substrates that Demonstrate Superhydrophilicity, Suitable for use as Medical Devices”, filed Nov. 18, 2021, and U.S. Provisional Patent Application Ser. No. 63/281,280, titled “Coated Substrates that Demonstrate Superhydrophilicity, Suitable for use as Medical Devices”, filed Nov. 19, 2021, and incorporated by reference in their entireties.

### FIELD OF THE INVENTION

The present invention relates to coated components of oil or gas operation equipment, the components having thin coatings that demonstrate superhydrophilicity and fouling resistance. The present invention is further related to methods of inhibiting fouling of oil or gas operation components.

### BACKGROUND OF THE INVENTION

Changing the surface energy of a substrate is of great value in many diverse industries and products, including oil, gas and energy production and other operations in the oil and gas industry. Depending on the needs and applications, substrate surfaces can be customized to exhibit hydrophilic, hydrophobic, oleophobic and oleophilic properties. Exceptionally hydrophilic surfaces are particularly desired in certain environments to prevent fouling of equipment by inorganic scale (e.g. calcium carbonate, barium sulfate and magnesium carbonate), tar, resins, aromatic hydrocarbons, alkanes, bitumens, paraffinic compounds and/or asphaltene-type compounds.

Scientifically, liquids with lower surface tensions (e. g., oil with surface tensions less than 30 mN/m) tend to wet solid surfaces (with specific surface energy) more than liquids with higher surface tensions (e. g., water with surface tension of 72.8 mN/m). Coated surfaces may be prepared to yield different contact angles for liquids with higher surface tensions compared to those with lower surface tensions.

A current solution to this problem of fouling of surfaces is through the use of fluorinated coatings that can resist significant adsorption of the organic fouling compounds. While these treatments are certainly effective for organic compounds, they have been found to increase the adsorption of inorganic scale. Furthermore, they contain perfluorinated compounds that are suspected to be hazardous and are highly persistent in the environment.

Even more critical is that the hydrophilic coatings (e. g., polyethylene glycol-based coatings) that have been developed as anti-scale coatings cannot repel hydrocarbon-based contaminants, so there is currently no effective strategy to repel both hydrocarbon and inorganic fouling compounds with surface treatments.

The modification of substrate surfaces with superhydrophilic polymers has also been proposed, using controlled radical polymerization (CRP) processes to dictate polymer architecture. Polymerization of hydrophilic monomers, in particular, (meth)acrylamide monomers that may provide such extreme hydrophilicity has historically been difficult to achieve via controlled radical polymerization processes such as ATRP, likely due to the exceptionally high rate of polymerization of these monomers as well as their chemical interaction with the copper-based catalysts typically used for such polymerization processes.

In addition, running these polymerizations in water adds another significant challenge due to the fact that ATRP initiators are usually activated alkyl halide compounds, which are highly prone to hydrolysis and rapidly lose their ability to control polymerization. When these polymerizations are conducted on surfaces in an aqueous medium, the ratio of initiating groups to water is many orders of magnitude in favor of water, making hydrolysis reactions far more likely than propagation of a polymer from an initiating site. Hence, the reported attempts of ATRP of (meth)acrylamide polymers in water are scarce, and surface-propagated polymerizations of them are absent from the literature to our knowledge.

Modifying the surfaces of substrates, including some modification methods that use CRP processes, tend to have drawbacks that make them unsuitable for many substrates because these processes typically employ solvents that are too aggressive, leading to degradation and/or swelling of a polymer substrate, or corrosion of a metal substrate caused by such solvents. For example, the most commonly used strategies for binding a polymerization initiator to a polymer surface use aggressive chemical attack to create functional groups (like hydroxyl, amine, etc.), followed by exposure to polar aprotic solvents such as diethyl ether, dichloromethane, etc., containing the initiator (for example, alpha-bromoisobutryl bromide) and a base catalyst such as triethylamine.

These methodologies are too aggressive to be used on most polymers, excepting highly fluorinated or crosslinked aromatic polymers such as PTFE, PFA, polyimide and PEEK. Commonly used polymers such as polyamide, pebax, acrylics, polyesters, polyolefins, PVC, and the like, are rapidly degraded by the aforementioned processes.

It would be desirable to provide coated components of oil or gas operation equipment that demonstrate superhydrophilicity and fouling resistance, and methods of inhibiting fouling of oil or gas operation components by both organic and inorganic contaminants.

### SUMMARY OF THE INVENTION

One aspect of the present invention provides at least one coated oil or gas operation component comprising:
(a) a substrate with a surface having reactive functional groups;
(b) a polymerization initiator, such as a controlled radical polymerization initiator, chemically bonded to at least one surface of substrate via reaction with the reactive functional groups on the surface of the substrate; and
(c) a polymeric coating layer. The polymeric coating layer is prepared by a radical polymerization process from a monomer composition, such as an aqueous monomer composition comprising at least one free radical polymerizable monomer having at least one hydrophilic functional group. The polymeric coating layer is chemically bonded to and propagated from the polymerization initiator, and the polymeric coating layer demonstrates hydrophilicity.

The invention further provides at least one coated oil or gas operation component comprising:
(a) a substrate with a surface having reactive functional groups;
(b) a controlled radical polymerization initiator chemically bonded to at least one surface of substrate via reaction with the reactive functional groups on the surface of the substrate; and
(c) a polymeric coating layer prepared by a controlled radical polymerization process from an aqueous monomer composition comprising at least 50 percent by weight, based on the total weight of monomers in the monomer composition, of at least one (meth)acrylamide monomer having at least one ionic functional group, and wherein the polymeric coating layer is chemically bonded to and propagated from the controlled radical polymerization initiator (b); and wherein the polymeric coating layer demonstrates a water contact angle less than 10°, and wherein said coated oil or gas operation component retains a water contact angle of less than 10° after immersion in phosphate buffered aqueous saline solution at 22° C. for a period of 28 days.

The invention further provides methods of inhibiting fouling of an oil or gas operation component by a contaminant comprising:
(a) chemically bonding a polymerization initiator to at least one surface of a substrate of the component, wherein the substrate comprises a surface having reactive functional groups, and the polymerization initiator is chemically bonded to the substrate via reaction with the reactive functional groups on the surface of the substrate to form an activated surface;
(b) contacting the activated surface with an aqueous monomer composition comprising at least one free radical polymerizable monomer having at least one hydrophilic functional group; and
(c) allowing the monomers in the aqueous monomer composition to polymerize via a radical polymerization process to form a polymeric coating layer, wherein the polymeric coating layer is chemically bonded to and propagated from the polymerization initiator (b).

### BRIEF DESCRIPTION OF THE DRAWINGS

FIGS. 1A and B are schematic isometric side and end views, respectively, of a coated oil operation component; in particular a storage tank, of the present invention.

FIG. 2 is a schematic molecular-scale view of a portion of a coated oil operation component of the present invention.

FIG. 3 is a schematic view of a particular example of a substrate suitable for use in a coated oil operation component of the present invention. The substrate in this example comprises a polymeric film, wherein the film comprises two opposing surfaces, and wherein an adhesive is applied on one surface of the polymeric substrate as a backing.

FIG. 4 is a schematic side view of a coated oil operation component; in particular a heat exchanger, of the present invention.

FIGS. 5A and 5B are representative schematic side views of coated oil operation components; in particular filters: a sieve particle filter (FIG. 5A) and a drum filter (FIG. 5B), of the present invention.

FIG. 6 is a schematic side view of a coated oil operation component; in particular a coalescer, of the present invention.

FIG. 7 is a representative schematic side view of coated oil operation components; in particular a well and flow control devices such as valves, of the present invention.

FIG. 8 is a schematic view of a coated oil operation component; in particular a blowout preventer, of the present invention.

FIG. 9 is a schematic side view of a coated oil operation component; in particular an undersea “Christmas tree”, of the present invention.

FIG. 10 is a schematic view of a coated oil operation component; in particular a lab-on-a-chip device with coated microfluidic channels, of the present invention.

FIG. 11 is a schematic view of a coated oil operation component; in particular a oil spill remediation equipment (floating boom), of the present invention.

FIG. 12 is a schematic side view of a coated oil operation component; in particular an oil skimmer, of the present invention.

FIG. 13 is a schematic view of a coated oil operation component as used; in particular oil spill remediation equipment (absorbent sponge/pad), of the present invention.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various aspects and examples of the present invention as presented herein are each understood to be non-limiting with respect to the scope of the invention.

As used in the following description and claims, the following terms have the meanings indicated below:

The terms “on”, “appended to”, “affixed to”, “bonded to”, “adhered to”, or terms of like import means that the designated item, e.g., a coating, film or layer, is either directly connected to (in contact with) the object surface, or indirectly connected to the object surface, e.g., through one or more other coatings, films or layers.

While not intending to be bound by theory, the premise of the present invention is that if a highly hydrophilic polymer is first chemically bonded to and propagated from surfaces it can help prevent or even reverse fouling of the surface by contaminants, due to the strength of adsorption of water molecules to the surface. The surface, rendered hydrophilic by the polymer propagated therefrom, preferentially adsorbs water instead of any contaminants in a fluid stream with which the surface comes into contact. It has also been determined that these polymers cannot be simply cast or adsorbed, or they will dissolve from the component surface; they must be chemically bound to the surface. Moreover, copolymerization with water-insoluble comonomers to keep the polymer stable only creates slight hydrophilicity, which is not strongly attracted enough to water to resist/desorb the aforementioned contaminants.

The coated oil or gas operation component 10 of the present invention comprise (a) a substrate 12 with a surface having reactive functional groups. Substrates suitable for use in the preparation of the components of the present invention can include silicon oxide, a metal selected from at least one of aluminum, copper, stainless steel, a metal oxide, nitinol, palladium, nickel, tantalum and titanium; or a polymer selected from at least one of a polyamide, a polyamide-polyether block copolymer, a poly(meth)acrylate, a polyester, a polyolefin, a polyisoprene, a polyurethane, a polyester-polyurethane copolymer, a polyimide, a cycloolefin polymer, a polyether ketone, a polysulfone, a polycarbonate and a polysiloxane.

The substrate 12 may be porous or nonporous. Porous substrates may be inherently porous or may be perforated with ordered or random microarrays of microchannels. “Microchannels” are understood to be micro-dimensional fluidic channels (e. g., having average diameters on a micron or nanometer scale). In microtechnology, a microchannel is understood to have a hydraulic diameter below 1 millimeter, such as below 500 microns, or below 100 microns, or below 1 micron.

The substrate 12 has reactive functional groups on the surface. Suitable functional groups include active hydrogen groups such as hydroxyl, amino, amido, thiol, carboxylic acid, and the like. The reactive functional groups allow for chemical bonding between the substrate (a) and a polymerization initiator 14, as shown in FIG. 2.

The substrate 12 may take any shape as desired for the intended application, such as flat, including planar or corrugated, curved, bowl-shaped, tubular, or flexible freeform, depending on the final product. For example, the substrate 12 may be in the form of a flat plate or sheet having two opposing surfaces. The thickness of the substrate 12 likewise depends on the nature of the final product. The polymeric coating layer 16 may be formed on at least one, up to all of the surfaces of the substrate 12, such as both of two opposing surfaces or the interior surfaces of a component such as a pipe or tank.

In a particular example shown in FIG. 3, the substrate 12 comprises a polymeric (e. g., polyethylene, polypropylene, or polyamide such as nylon) film 22. The film 22 comprises two opposing surfaces 26 and 28, wherein an adhesive layer 24 such as a pressure sensitive adhesive is applied on one surface 28 of the polymeric substrate 12 as a backing, allowing for preparation of the opposing surface 26 with the initiator and polymeric coating layer to form a coated substrate. The coated substrate may then be applied via the adhesive to any component, including a prefabricated component, to produce the coated oil or gas operation component. Such a coated substrate with an adhesive backing allows for applying the coated film to components onsite in the field.

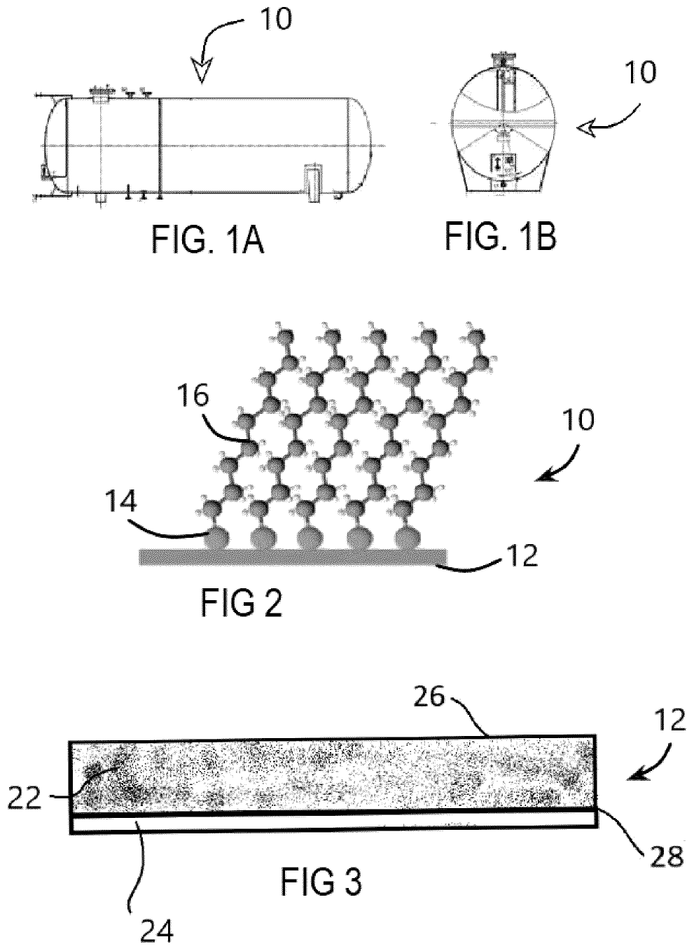

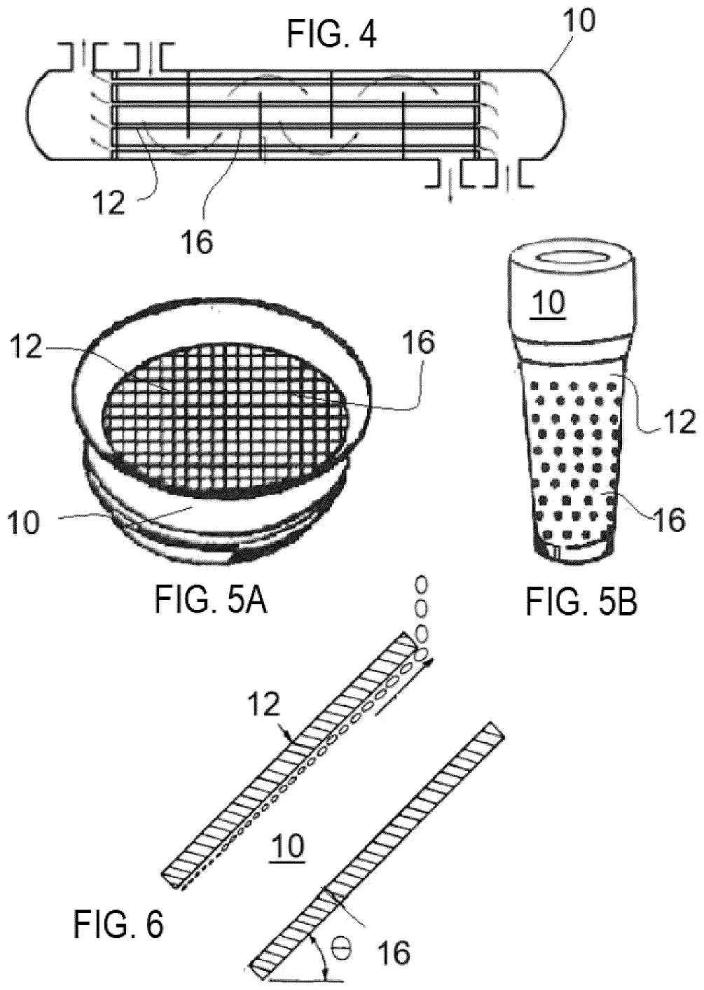

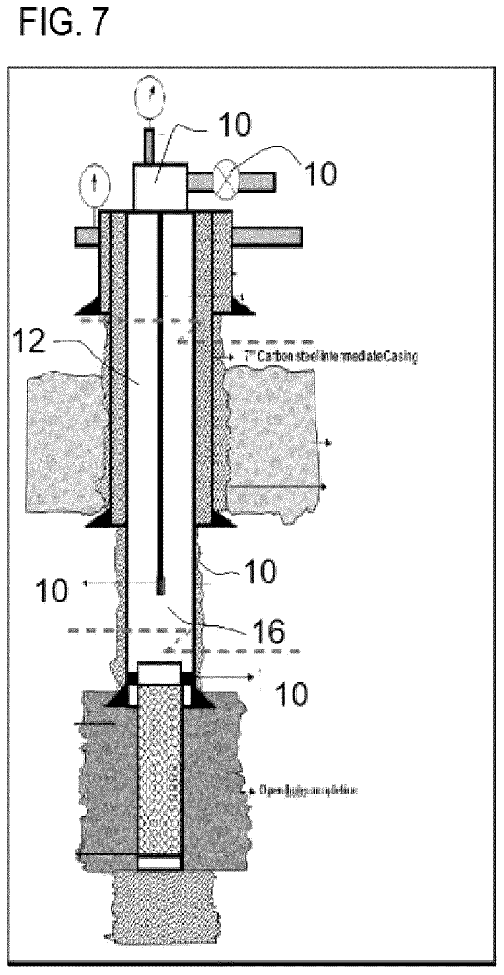

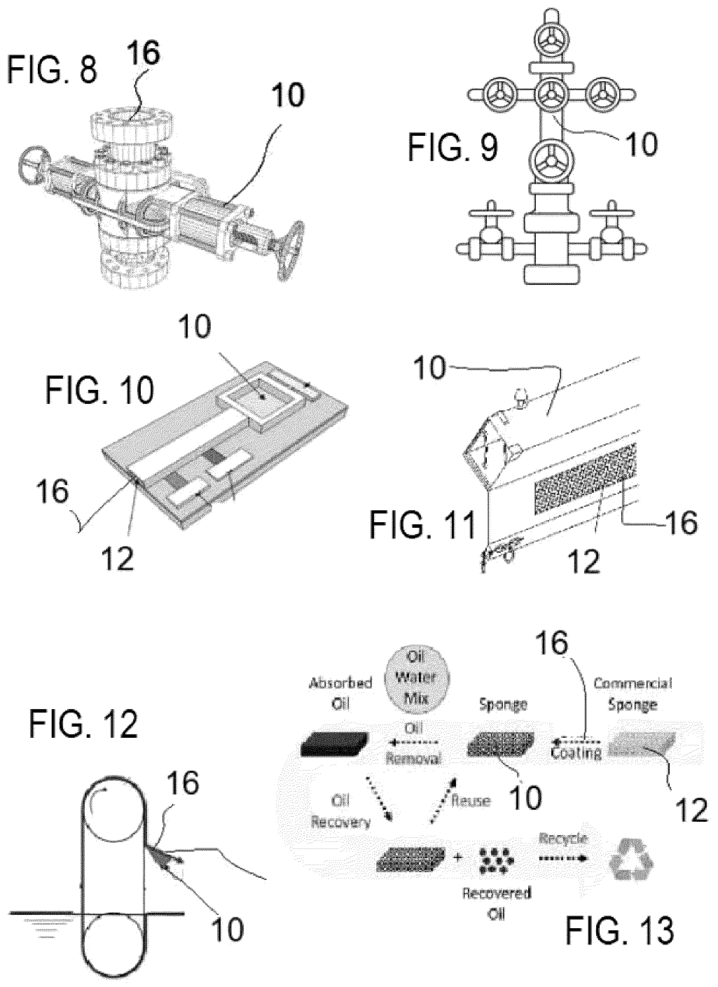

The oil or gas operation component 10 may comprise any production, transport, or other operation component of the oil and gas industry; for example, a flow conduit (i. e., fluidic channels such as a pipe, pipeline or microchannel); a coalescer plate as shown in FIG. 6; a pump (e. g., rod pump); a well (see FIG. 7 for a representative well) such as a closed loop CO₂ geothermal well, a storage well, or a CO₂ injector well for Enhanced Oil Recovery (EOR) or Coal Bed Methane (CBM) extraction operations; a tank, as shown in FIGS. 1A and 1B (such as a transportable ISO or other storage tank, or a holding tank); a heat exchanger as shown in FIG. 4; a filter (see FIGS. 5A and 5B for representative drawings of a sieve particle filter (FIG. 5A) and a drum filter (FIG. 5B); drilling equipment such as pipes and bits; an offshore oil or wind turbine platform including structural supports; a blowout preventer as shown in FIG. 8; casing; a flow control device (valve as shown in FIG. 7 or eductor); a measurement device (such as for temperature, pressure, fluid level or flow rate); a sensor (such as a temperature or fluid level sensor); a viewport; oil spill remediation equipment such as skimmers as shown in FIG. 12, absorbent pads as shown in FIG. 13 and booms as shown in FIG. 11, containment barriers, separators, response robots and bioremediation equipment; undersea “Christmas trees” as shown in FIG. 9; or oil processing equipment. The polymeric coating layer is typically formed on a surface of the component that will come in contact with hydrocarbons, such as the interior of a pipe or tank, but may be formed on any or all surfaces of a component.

Non-limiting examples of suitable heat exchangers include those used on offshore oil platforms, in refinery operations, in natural gas processing, and petrochemical plants. For example:
1. Shell and Tube Heat Exchangers: These exchangers, as shown in FIG. 4, may be coated on the internal tubes and/or shell surfaces. Benefits: Reduces fouling from hydrocarbons, prevents corrosion from aggressive chemicals, and improves heat transfer efficiency.
2. Plate Heat Exchangers: Coatings can be applied to the plates, which are often made from metals prone to fouling and corrosion. Benefits: Enhances resistance to chemical attack, reduces scaling, and prevents the build-up of residue, which helps maintain performance and simplifies maintenance.
3. Air Cooled Heat Exchangers: Finned surfaces may be coated to prevent fouling from airborne particulates and environmental contaminants. Benefits: Improves heat transfer efficiency by keeping fins clean and functional, extends the service life of the exchanger.
4. Double Pipe Heat Exchangers: Coating the internal and external surfaces of the pipes prevents fouling and corrosion. Benefits: Reduces maintenance frequency and costs by preventing scale and sediment build-up inside the pipes.
5. Spiral Heat Exchangers: Coating the spiral plates or the internal surfaces protects against fouling and corrosion. Benefits: Ensures a longer operational life and consistent performance by minimizing deposit formation and corrosion.

Non-limiting examples of suitable filters include those used on offshore oil platforms, in refinery operations, in oil sands operations, and gas processing facilities. For example:
1. Particle Filters: Coated filter media as shown in FIGS. 5A and 5B can be used in systems designed to capture particulate matter from crude oil or natural gas. Benefits: The coating's hydrophilic properties and low contact angle reduce the adhesion of particles, preventing clogging and ensuring consistent filtration performance.
2. Hydrocarbon Filters: Used to separate hydrocarbons from water or other fluids in various processes, such as in produced water treatment. Benefits: The coating helps prevent fouling from hydrocarbons and minimizes the accumulation of sticky residues, extending the filter's lifespan and efficiency.
3. Chemical Process Filters: Coated filter media can be applied in chemical filtration processes where corrosive or reactive chemicals are present. Benefits: The coating provides a protective layer that resists chemical attack and corrosion, thereby maintaining the integrity and effectiveness of the filter.
4. Gas Filtration Systems: In gas processing and refining, filter media coated with such polymers can be used to remove contaminants or particulates from gases. Benefits: The polymeric coating enhances resistance to gas-phase fouling and extends the service life of the filter.
5. Desalination Systems: In desalination processes for treating water used in oil and gas operations, coated filter media can be employed. Benefits: The coating prevents fouling and scaling from salts and minerals, ensuring efficient filtration and longevity of the filter media.
6. Catalyst Filters: Used in catalytic reactors to filter out particulates or contaminants that could poison the catalyst. Benefits: The coating helps to prevent the build-up of residues that could degrade the filter or affect the catalytic process.

Non-limiting examples of fluidic microchannels include:
1. Microfluidic Sensors for Fluid Analysis: Coated microchannels may be used in microfluidic sensors to analyze the properties of crude oil, natural gas, and other fluids. Benefits: The polymeric coating reduces fouling and ensures consistent, reliable sensor performance even in harsh conditions.
2. Enhanced Oil Recovery (EOR) Systems: Coated microchannels may be utilized in EOR techniques to precisely control the injection of chemicals, gases, or water into reservoirs. Benefits: The coating helps maintain the integrity and performance of microchannels by preventing blockage and corrosion, thereby enhancing the efficiency of EOR processes.
3. Lab-on-a-Chip Devices for On-Site Testing: Coated microfluidic channels may be used in lab-on-a-chip devices as shown in FIG. 10 for real-time, on-site testing of oil and gas samples. Benefits: The hydrophilic nature and low contact angle of the coating improve fluid movement and mixing within the microchannels, leading to more accurate and faster test results.
4. Chemical Reactors for Synthesis and Catalysis: Coated microchannels may be employed in microreactors for synthesizing chemicals or catalyzing reactions at small scales. Benefits: The coating ensures that the microchannels remain free of fouling and chemical buildup, improving reaction efficiency and consistency.
5. Water Treatment and Separation Units: Coated microchannels may be used in water treatment systems to separate oil, gas, and water phases. Benefits: The polymeric coating enhances separation efficiency by preventing the accumulation of organic and inorganic contaminants.
6. Gas Processing and Purification: Coated microchannels may be implemented in gas processing units to control the flow and purification of gases such as methane, ethane, and propane. Benefits: The coating's resistance to chemical fouling and corrosion ensures prolonged functionality and reliability of the microchannels in gas processing.

Non-limiting examples of oil spill remediation equipment include:
1. Absorbent Materials and Pads: Coated absorbent pads and materials as shown in FIG. 13 may be used to soak up oil from water surfaces. Benefits: The hydrophilic polymeric coating ensures rapid and efficient absorption of oil, reducing the time required for cleanup. The coating also minimizes water uptake, increasing the oil absorption capacity.
2. Booms and Barriers: Floating booms and barriers coated with the polymeric material as shown in FIG. 11 may be deployed to contain and prevent the spread of oil spills. Benefits: The hydrophilic and anti-fouling properties of the coating prevent the adherence of oil and debris, maintaining the effectiveness of the booms over extended periods.
3. Skimmers: Mechanical skimmers equipped with coated surfaces as shown in FIG. 12 may be used to remove oil from the water surface. Benefits: The low contact angle of the coating reduces the resistance of oil flow, enhancing the skimmer's efficiency in collecting oil. The anti-fouling properties also reduce maintenance needs.
4. Oil-Water Separators: Coated components within oil-water separators may help in the efficient separation of oil from water. Benefits: The hydrophilic coating facilitates the flow and separation process by reducing clogging and fouling, ensuring continuous operation and reducing downtime.
5. Filter Media: Filters with coated media may be used in oil spill remediation systems to trap and remove oil particles from water (see representative filters in FIGS. 5A and 5B). Benefits: The coating improves the filter's oil affinity and retention capacity while minimizing water uptake, leading to more effective oil removal.
6. Sorbent Booms: Coated sorbent booms as shown in FIG. 11 may be deployed in water to absorb and contain oil spills. Benefits: The polymeric coating enhances the hydrophilicity and oil absorption capacity, making the booms more efficient in oil spill containment and cleanup.
7. Oil Recovery Pumps: Pumps with coated internal components may be used to recover oil from the water surface. Benefits: The coating's low contact angle ensures smooth and efficient oil flow through the pump, reducing energy consumption and increasing recovery efficiency. The anti-corrosion properties extend the pump's lifespan.
8. Oil-Absorbing Sponges: Coated sponges as shown in FIG. 13 may be used to absorb oil from contaminated water bodies. Benefits: The polymeric coating enhances the sponge's oil absorption efficiency while resisting water, making it more effective in cleanup operations.

Before bonding the polymerization initiator 14 to the substrate 12, the surface of the substrate 12 may be modified by any of a variety of well-known techniques such as corona or argon plasma discharge, or chemical etching (particularly using a NaOH or KOH solution), to generate the reactive functional groups, such as hydroxyl, amido, thiol, carboxylic acid, epoxy and/or amine functional groups on the substrate surface.

Alternatively, an activated layer comprising metal may be applied to the substrate to form the reactive functional groups on the substrate. When this method is used, the activated layer may comprise one or more of Ti, Cr, Al, Ta, Nb, Ni, silver oxide, gold oxide, palladium oxide, platinum oxide, rhodium oxide, iridium oxide, tantalum oxide, aluminum oxide, copper oxide, titanium oxide, iron oxide, zirconium oxide, silicon oxide and chromium oxide.

The coated oil or gas operation components 10 of the present invention further comprise (b) a polymerization initiator 14 chemically bonded to at least one surface of the substrate 12 via reaction with the reactive functional groups on the surface of the substrate 12. The polymerization initiator 14 may be bonded to the substrate 12 using conventional techniques, including physical vapor deposition (PVD) or chemical vapor deposition (CVD), to ensure a thin layer of molecular dimensions.

Any initiators known in the art for radical polymerization processes, in particular, living (i. e., controlled radical) polymerization processes are suitable, provided they may be chemically bonded to the substrate surface by reaction with the reactive functional groups. Organosilicon compounds may serve as an initiator. Suitable organosilicon compounds include alkoxysilane functional compounds such as (3-trimethoxysilyl)propyl-2-bromo-2-methylpropionate. Also suitable are organosilicon-containing compounds with ethylenically unsaturated groups, such as (3-trimethoxysilyl)propyl (meth)acrylate, and (3-trimethoxysilyl)propyl (meth)acrylamide. Also useful are organophosphorus acids chemically bonded to the substrate surface, wherein the organo portion of the organophosphorus acid contains an initiator moiety such as a halide group (e.g., bromide, chloride, or iodide). Other halide-containing compounds including benzyl halides, 2-halo-propionitriles, alkyl or acyl halide compounds, such as isobutyryl halides, a-halooisobutyryl halide (e. g. a-bromoisobutyryl bromide), are also suitable. Azo-initiators such as azobisbutyronitrile (AIBN), 1,1′-azobis(cyclohexanecarbonitrile), and 4,4-azobis (4-cyanopentanoic acid), and K₂S₂O₈, as used in addition-fragmentation chain transfer (RAFT) polymerization processes may also be employed.

The coated oil or gas operation component 10 of the present invention further comprise (c) a hydrophilic polymeric coating layer 16. The polymeric coating layer 16 is chemically bonded to and propagated from the polymerization initiator 14.

The polymeric coating layer 16 may be prepared from an aqueous monomer composition comprising at least one free radical polymerizable monomer having at least one hydrophilic functional group. Any monomer capable of free-radical polymerization may be used in the aqueous monomer composition. Examples of particularly suitable monomers include hydrophilic styrene functional monomers, acrylonitrile, (meth)acrylamide functional monomers, 4-vinylpyridine, sodium 4-vinylbenzenesulfonate, and monomers that are quaternized with a halide (e.g., chloride or fluoride) or have functional groups that are capable of being quaternized with a halide after polymerization. Other suitable monomers include dienes, alkylvinyl monomers or allyl ethers.

In a particular example, the polymeric coating layer 16 may be prepared from an aqueous monomer composition comprising at least 50 percent by weight, based on the total weight of monomers in the monomer composition, of at least one (meth)acrylamide monomer having at least one ionic functional group. For example, the polymeric coating layer 16 may be formed from an aqueous monomer composition comprising at least one of a (meth)acrylamide halide salt, 2-aminoethylmethacrylamide hydrochloride halide salt, N,N′-(3-(dimethylamino)propyl) methacrylamide, N,N-(3-dimethylamino)propyl)-methacryloylaminobutyl sulfonate, N,N-(3-dimethylamino)propyl)-methacryloylaminopropyl sulfonate, 2-acrylamidopropane-2-methyl-1-propane sulfonic acid salt, [3-(methacryloylamino)propyl]trimethylammonium chloride, [3-(acryloylamino)propyl]trimethylammonium chloride, N,N′-dimethyl(meth)acrylamide and salts thereof, and 3-[(3-(meth)acrylamidopropyl)dimethylammonio]propanoate. The polymeric coating layer 16 may comprise a homopolymer of any of the above monomers, or may comprise a copolymer, such as a block copolymer, of two or more of the above monomers, designed to provide both hydrophilic and additional antifouling properties.

The polymeric coating layer 16 is typically prepared via a radical polymerization process, such as a controlled radical polymerization (CRP) or “living” process; i. e., a chain-growth polymerization that propagates with essentially no chain transfer and essentially no chain termination. The molecular weight of a polymer prepared by CRP can be controlled by the stoichiometry of the reactants, i.e., the initial concentration of monomer(s) and initiator(s). In addition, CRP also provides polymers having characteristics including, for example, narrow molecular weight distributions, e. g., PDI values less than 2.5, and well-defined polymer chain architecture, e. g., block copolymers and alternating copolymers. As used herein, the term “controlled radical polymerization” and related terms such as “controlled radical polymerization process” includes, but is not limited to, atom transfer radical polymerization (ATRP), single electron transfer polymerization (SETP), reversible addition-fragmentation chain transfer (RAFT), and nitroxide-mediated polymerization (NMP).

In forming the coated components 10 of the present invention, the surface of the substrate 12 is first contacted with initiator molecules to chemically bond the initiator 14 to the substrate 12 via reaction with the reactive functional groups on the surface of the substrate 12 to form an activated surface. The activated surface is then contacted with the monomer composition described above and a CRP catalyst, and polymerized under CRP conditions in an aqueous medium to form a layer or film 16 of (meth)acrylamide-containing polymer. The components may be coated after they are manufactured, or the substrate 12 used to prepare the component, e. g., a metal coil, may be coated in-line in a roll-to-roll process prior to shaping the substrate into a component. The polymeric coating layer 16 is formed on surfaces of the component that will come in contact with hydrocarbons or other foulants, such as the interior of a tank or pipe.

In an example using ATRP, the substrate surface having reactive functional groups is contacted with a compound containing in a terminal portion a functional group reactive with the reactive functional groups on the substrate surface, and in a second terminal portion, an initiator for ATRP. A self-assembled monolayer (SAM) is formed from the compound bonded to the substrate surface, with the initiator 14 outwardly from the substrate surface. The SAM is contacted with an aqueous mixture comprising the monomer composition and an ATRP catalyst, and the monomer composition is polymerized to form a layer of (meth)acrylamide-containing polymer on the substrate surface, chemically bonded to and propagated from the polymerization initiator 14.

The ATRP polymerization catalyst is typically a transition metal compound, which participates in a reversible redox cycle with the initiator; and a ligand, which coordinates with the transition metal compound. The ATRP process is described in further detail in International Patent Publication No. WO 98/40415 and U.S. Pat. Nos. 5,807,937, 5,763,548 and 5,789,487 which are incorporated herein by reference.

Catalysts that may be used in the ATRP preparation include any transition metal compound. It is preferred that the transition metal compound not form direct carbon-metal bonds with the polymer chain. Transition metal catalysts useful in the present invention may be represented by the following general formula:

Mⁿ⁺Xₙ

wherein M is the transition metal, n is the formal charge on the transition metal having a value of from 0 to 7, and X is a counterion or covalently bonded component. Examples of the transition metal M include, but are not limited to, Cu, Fe, Au, Ag, Hg, Pd, Pt, Co, Mn, Ru, Mo, Nb and Zn. Examples of X include, but are not limited to, halide, hydroxy, oxygen, C₁-C₆ alkoxy, cyano, cyanato, thiocyanato and azido. A preferred transition metal is Cu(I) and X is preferably halide, e.g., chloride. Accordingly, a preferred class of transition metal catalyst is the copper halides, e.g., Cu(I)Cl. It is also preferred that the transition metal catalyst contain a small amount, e.g., 1 mole percent, of a redox conjugate, for example, Cu(II)Cl₂, when Cu(I)Cl is used. Additional catalyst useful in preparing the pigment dispersant are described in U.S. Pat. No. 5,807,937 at column 18, lines 29 through 56 which patent is incorporated herein by reference in its entirety. Redox conjugates are described in further detail in U.S. Pat. No. 5,807,937 at column 11, line 1 through column 13, line 38 which patent is incorporated herein by reference in its entirety.

Ligands that may be used in ATRP for preparation of the polymerization catalyst include compounds having one or more nitrogen, oxygen, phosphorus and/or sulfur atoms, which can coordinate to the transition metal catalyst compound, e. g., through sigma and/or pi bonds. Classes of useful ligands include tertiary aliphatic amines, unsubstituted and substituted pyridines and bipyridines; porphyrins; cryptands; crown ethers; e.g., 18-crown-6; polyamines, e.g., ethylenediamine; glycols, e.g., alkylene glycols, such as ethylene glycol; carbon monoxide; and coordinating monomers, e.g., styrene, acrylonitrile and hydroxyalkyl(meth)acrylates. Note that the phrase “and/or” when used in a list is meant to encompass alternative embodiments including each individual component in the list as well as any combination of components. For example, the list “A, B, and/or C” is meant to encompass seven separate embodiments that include A, or B, or C, or A+B, or A+C, or B+C, or A+B+C.

As used herein and in the claims, the term “(meth)acrylate” and similar terms refer to acrylates, methacrylates and mixtures of acrylates and methacrylates; similarly for (meth)acrylamide. A preferred class of ligands are the substituted bipyridines, e.g., 4,4′-dialkyl-bipyridyls. Additional ligands that may be used in preparing pigment dispersant are described in U.S. Pat. No. 5,807,937 at column 18, line 57 through column 21, line 43 which patent is incorporated herein by reference in its entirety.

The reducing agent may be any reducing agent capable of reducing the transition metal catalyst from a higher oxidation state to a lower oxidation state, thereby reforming the catalyst activator state. Such reducing agents include, for example, SO₂, sulfites, bisulfites, thiosulfites, mercaptans, hydroxylamines, hydrazine (N₂H₄), phenylhydrazine (Ph-NHNH₂), hydrazones, hydroquinone, food preservatives, flavonoids, beta carotene, vitamin A, α-tocopherols, vitamin E, propyl gallate, octyl gallate, BHA, BHT, propionic acids, ascorbic acid, sorbates, reducing sugars, sugars comprising an aldehyde group glucose, lactose, fructose, dextrose, potassium tartrate, nitriles, nitrites, dextrin, aldehydes, glycine, and transition metal salts. Water-soluble reducing agents are particularly suitable.

The above-mentioned ingredients are typically dissolved or suspended in an aqueous medium, which may include in minor portions a diluent such as an organic solvent; for example, acetone or methanol. Also, solvents such as those containing oligo ethylene oxide and propylene oxide groups, such as diethylene glycol, diethylene glycol monomethyl ether and tripropylene glycol monomethyl ether may be used in minor portions. Such solvents may boost the activity of the catalyst. The concentration of the radically polymerizable monomers is typically from 5 to 70 percent by weight based on total weight of solution. The molar ratio of catalyst to monomer ranges from 1:5 to 1:500, such as 1:20 to 1:100; the molar ratio of ligand to catalyst ranges from 1:2 to 1:100, such as 1:2 to 1:5. The molar ratio of reducing agent to catalyst is from 1:0.1 to 10 such as 1:0.5 to 2.

The aqueous solution of the radically polymerizable monomer composition can be applied to the initiator-coated substrate (i. e., the activated surface) by conventional means such as dipping, rolling, spraying, printing, stamping or wiping to ensure uniform coating of the substrate surface. The solution may be applied to the entire substrate surface or over a portion thereof, such as in a predetermined pattern using a mask. The formation of the ATRP film or coating can occur at temperatures in the range of −10 to 150° C. and at pressures of 1-100 atmospheres, usually at ambient temperature and pressure. By “ambient” conditions is meant without the application of heat or other energy; for example, when a curable composition undergoes a thermosetting reaction without baking in an oven, use of forced air, irradiation, or the like to prompt the reaction, the reaction is said to occur under ambient conditions. Usually, ambient temperature ranges from 60 to 90° F. (15.6 to 32.2° C.), such as a typical room temperature, 72° F. (22.2° C.). The time for conducting the ATRP can vary depending on the thickness of the film desired. The polymeric coating layer 16 typically has a thickness greater than 50 nm and less than 2.5 microns, such as less than 2 microns, or less than 1 micron, or even less than 100 nm. Such thick coating layers of aqueous CRP-generated (meth)acrylamide polymer coating layers have not been achieved previously; the thickness of the coating contributes to lubricity. The thickness of the film can be monitored by Quartz Crystal Microgravometric (QCM) measurement and the time for the ATRP is typically from 30 to 600 minutes. After ATRP, the coated substrate is removed from any remaining solution by rinsing with a polar solvent and drying the coated substrate.

When the activated surface of the initiator-coated substrate is exposed to the aqueous solution of the radically polymerizable monomer composition and subjected to ATRP conditions, the monomers contained therein form covalent bonds with each other and with the initiator groups that are bonded to the surface of the substrate. As mentioned above, the resultant coating or film is relatively thick (compared to typical surface ATRP processes) with strong adhesion to the substrate. The resulting polymer has a low polydispersity index because chain transfer reactions are minimized. Lower polydispersity indices enable the molecular weight of the polymer to be controlled and optimized for the particular application intended.

The process may further include subjecting the coated substrate to heat or UV radiation to effect curing of any reactive functional groups on the polymers of the polymeric coating layer. Such curing may further ensure a robust and durable polymeric coating layer.

The term “cure”, “cured” or similar terms, as used in connection with a cured or curable composition, e.g., a “cured composition” of some specific description, means that at least a portion of any polymerizable and/or crosslinkable components that form the curable composition is polymerized and/or crosslinked. Additionally, curing of a composition refers to subjecting said composition to curing conditions such as heating or exposure to actinic radiation, depending on the chemistry, leading to the reaction of any reactive functional groups in the composition. The term “at least partially cured” means subjecting the composition to curing conditions, wherein reaction of at least a portion of the reactive groups of the composition occurs. The composition can be subjected to curing conditions as necessary depending on the composition of the coating layers, such that a substantially complete cure is attained and wherein further curing results in no significant further improvement in physical properties, such as hardness.

The resultant coated components 10 are hydrophilic, even superhydrophilic, demonstrating lubricity, and the polymeric coating layers 16 serve as easy clean coatings and antifouling coatings. The coating layer 16 often demonstrates a water contact angle less than 10°, typically less than 5°, and retains a contact angle of less than 10° after immersion in phosphate buffered (approximate pH of 7.4) aqueous saline solution at 22° C. for a period of 28 days, often greater than 28 days. Additionally, the coating layer 16 will not lose its hydrophilic or lubricious properties under these conditions. By “superhydrophilicity” is meant a high degree of hydrophilicity, or attraction to water; in superhydrophilic materials, the contact angle of water is less than 10°, often less than 5°, even equal to 0°. The coated oil or gas operation components 10 of the present invention demonstrate antifouling efficacy against a range of contaminants including inorganic scale, tar, resins, aromatic hydrocarbons, alkanes, bitumens, paraffinic compounds, and/or asphaltene-type compounds, confirmed through performance testing under relevant operational conditions.

The present invention is thus further drawn to a method of inhibiting fouling of an oil or gas operation component 10 by a contaminant such as inorganic scale (e.g. calcium carbonate, barium sulfate, magnesium carbonate), tar, resins, aromatic hydrocarbons, alkanes, bitumens, paraffinic compounds and/or asphaltene-type compounds. The component may be any of those disclosed above. The method comprises:
(a) chemically bonding a polymerization initiator 14, such as a controlled radical polymerization initiator, to at least one surface of a substrate 12 of the component, wherein the substrate comprises a surface having reactive functional groups, and the polymerization initiator is chemically bonded to the substrate via reaction with the reactive functional groups on the surface of the substrate to form an activated surface;
(b) contacting the activated surface with an aqueous monomer composition comprising at least one free radical polymerizable monomer having at least one hydrophilic functional group; and
(c) allowing the monomers in the aqueous monomer composition to polymerize via a radical polymerization process to form a polymeric coating layer 16, wherein the polymeric coating layer 16 is chemically bonded to and propagated from the polymerization initiator 14.

The substrate 12 may be any of those disclosed above, contacted with the aqueous monomer composition via spraying, brushing, or dipping, to form any of the polymers disclosed above.

Whereas particular embodiments of this invention have been described above for purposes of illustration, it will be evident to those skilled in the art that numerous variations of the details of the present invention may be made without departing from the scope of the invention as defined in the appended claims.

What is claimed is:

1. A coated oil or gas operation component comprising:
(a) a substrate with a surface having reactive functional groups;
(b) a polymerization initiator chemically bonded to at least one surface of the substrate via reaction with the reactive functional groups on the surface of the substrate; and
(c) a polymeric coating layer prepared by a radical polymerization process from a monomer composition comprising at least one free radical polymerizable monomer having at least one hydrophilic functional group, wherein the polymeric coating layer is chemically bonded to and propagated from the polymerization initiator (b); and wherein the polymeric coating layer demonstrates hydrophilicity.

2. The coated oil or gas operation component of claim 1, wherein the substrate (a) comprises silicon oxide, a metal selected from at least one of aluminum, copper, stainless steel, a metal oxide, nitinol, palladium, nickel, tantalum, and titanium; or a polymer selected from at least one of a polyamide, a polyamide-polyether block copolymer, a poly(meth)acrylate, a polyester, a polyolefin, a polyisoprene, a polyurethane, a polyester-polyurethane copolymer, a polyimide, a cycloolefin polymer, a polyether ketone, a polysulfone, a polycarbonate and a polysiloxane.

3. The coated oil or gas operation component of claim 1, wherein the surface of the substrate comprises hydroxyl, amido, thiol, carboxylic acid, epoxy and/or amine functional groups.

4. The coated oil or gas operation component of claim 1, wherein the polymerization initiator (b) comprises a halogen-containing compound.

5. The coated oil or gas operation component of claim 1, wherein the polymerization initiator (b) is a controlled radical polymerization initiator comprising an isobutyryl halide, a benzyl halide, a 2-halo-propionitrile, an α-haloisobutyryl halide, azobisbutyronitrile (AIBN), 1,1′-azobis(cyclohexanecarbonitrile), 4,4-azobis (4-cyanopentanoic acid), or potassium persulfate (K₂S₂O₈).

6. The coated oil or gas operation component of claim 1, wherein the polymeric coating layer (c) is formed from an aqueous monomer composition comprising at least one of a styrene functional monomer, acrylonitrile, (meth)acrylamide functional monomer, 4-vinylpyridine, sodium 4-vinylbenzenesulfonate, and a monomer that is quaternized with a halide or has functional groups that are capable of being quaternized with a halide after polymerization.

7. The coated oil or gas operation component of claim 1, wherein the polymeric coating layer (c) is formed from an aqueous monomer composition comprising at least one of a (meth)acrylamide halide salt, 2-aminoethylmethacrylamide hydrochloride halide salt, N,N′-(3-(dimethylamino)propyl) methacrylamide, N,N-(3-dimethylamino)propyl)-methacryloylaminobutyl sulfonate, N,N-(3-dimethylamino)propyl)-methacryloylaminopropyl sulfonate, 2-acrylamidopropane-2-methyl-1-propane sulfonic acid salt, [3-(methacryloylamino)propyl]trimethylammonium chloride, [3-(acryloylamino)propyl]trimethylammonium chloride, N,N′-dimethyl(meth)acrylamide and salts thereof, and 3-[(3-(meth)acrylamidopropyl)dimethylammonio]propanoate.

8. The coated oil or gas operation component of claim 1, wherein the polymeric coating layer (c) comprises a homopolymer of a (meth)acrylamide halide salt, 2-aminoethylmethacrylamide hydrochloride halide salt, N,N′-(3-(dimethylamino)propyl) methacrylamide, N,N-(3-dimethylamino)propyl)-methacryloylaminobutyl sulfonate, N,N-(3-dimethylamino)propyl)-methacryloylaminopropyl sulfonate, 2-acrylamidopropane-2-methyl-1-propane sulfonic acid salt, [3-(methacryloylamino)propyl]trimethylammonium chloride, [3-(acryloylamino)propyl]trimethylammonium chloride, N,N′-dimethyl(meth)acrylamide or salts thereof, or 3-[(3-(meth)acrylamidopropyl)dimethylammonio]propanoate.

9. The coated oil or gas operation component of claim 1, wherein the polymeric coating layer (c) comprises a block copolymer.

10. The coated oil or gas operation component of claim 1, wherein the component comprises a flow conduit, a coalescer plate, a pump, a closed loop CO₂ geothermal well, a storage well, a CO₂ injector well for Enhanced Oil Recovery (EOR) or Coal Bed Methane (CBM) extraction operations, a tank, a heat exchanger, a filter, drilling equipment, an offshore oil or wind turbine platform including structural supports, a blowout preventer, casing, a flow control device, a measurement device, a sensor, a viewport, oil spill remediation equipment, bioremediation equipment, undersea “Christmas trees”, or oil processing equipment, and wherein the polymeric coating layer is formed on a surface of the component that will come in contact with hydrocarbons or other foulants.

11. The coated oil or gas operation component of claim 1, wherein the component demonstrates antifouling by a contaminant comprising inorganic scale, tar, resins, aromatic hydrocarbons, alkanes, bitumens, paraffinic compounds and/or asphaltene-type compounds.

12. A coated oil or gas operation component comprising:
(a) a substrate with a surface having reactive functional groups;
(b) a controlled radical polymerization initiator chemically bonded to at least one surface of the substrate via reaction with the reactive functional groups on the surface of the substrate; and
(c) a polymeric coating layer prepared by a controlled radical polymerization process from an aqueous monomer composition comprising at least 50 percent by weight, based on the total weight of monomers in the monomer composition, of at least one (meth)acrylamide monomer having at least one ionic functional group, and wherein the polymeric coating layer is chemically bonded to and propagated from the controlled radical polymerization initiator (b); and
wherein the polymeric coating layer demonstrates a water contact angle less than 10°, and wherein said coated oil or gas operation component retains a water contact angle of less than 10° after immersion in phosphate buffered aqueous saline solution at 22° C. for a period of 28 days.

13. A method of inhibiting fouling of an oil or gas operation component by a contaminant comprising:
(a) chemically bonding a polymerization initiator to at least one surface of a substrate of the component, wherein the substrate comprises a surface having reactive functional groups, and wherein the polymerization initiator is chemically bonded to the substrate via reaction with the reactive functional groups on the surface of the substrate to form an activated surface;
(b) contacting the activated surface with an aqueous monomer composition comprising at least one free radical polymerizable monomer having at least one hydrophilic functional group; and
(c) allowing the monomers in the aqueous monomer composition to polymerize via a radical polymerization process to form a polymeric coating layer, wherein the polymeric coating layer is chemically bonded to and propagated from the polymerization initiator (b).

14. The method of claim 13, wherein the substrate comprises silicon oxide, a metal selected from at least one of aluminum, copper, stainless steel, a metal oxide, nitinol, palladium, nickel, tantalum and titanium; or a polymer selected from at least one of a polyamide, a polyamide-polyether block copolymer, a poly(meth)acrylate, a polyester, a polyolefin, a polyisoprene, a polyurethane, a polyester-polyurethane copolymer, a polyimide, a cycloolefin polymer, a polyether ketone, a polysulfone, a polycarbonate and a polysiloxane.

15. The method of claim 13, wherein the reactive functional groups are generated by corona or argon plasma discharge, or by chemical etching.

16. The method of claim 14, wherein the surface of the substrate comprises hydroxyl, amido, thiol, carboxylic acid, epoxy and/or amine functional groups.

17. The method of claim 14, wherein the activated surface is contacted with the aqueous monomer composition via spraying, brushing, or dipping.

18. The method of claim 14, wherein the polymeric coating layer comprises a homopolymer or copolymer of monomers selected from a styrene functional monomer, acrylonitrile, 4-vinylpyridine, sodium 4-vinylbenzenesulfonate, a monomer that is quaternized with a halide or has functional groups that are capable of being quaternized with a halide after polymerization, a (meth)acrylamide halide salt, 2-aminoethylmethacrylamide hydrochloride halide salt, N,N′-(3-(dimethylamino)propyl) methacrylamide, N,N-(3-dimethylamino)propyl)-methacryloylaminobutyl sulfonate, N,N-(3-dimethylamino)propyl)-methacryloylaminopropyl sulfonate, 2-acrylamidopropane-2-methyl-1-propane sulfonic acid salt, [3-(methacryloylamino)propyl]trimethylammonium chloride, [3-(acryloylamino)propyl]trimethylammonium chloride, N,N′-dimethyl (meth)acrylamide or salts thereof, and 3-[(3-(meth)acrylamidopropyl)dimethylammonio]propanoate.

19. The method of claim 14, wherein the polymeric coating layer comprises a block copolymer.

20. The method of claim 14, wherein the contaminant comprises inorganic scale, tar, resins, aromatic hydrocarbons, alkanes, bitumens, paraffinic compounds and/or asphaltene-type compounds and wherein the component comprises a flow conduit, a coalescer plate, a pump, a closed loop CO₂ geothermal well, a storage well, a CO₂ injector well for Enhanced Oil Recovery (EOR) or Coal Bed Methane (CBM) extraction operations, a tank, a heat exchanger, a filter, drilling equipment, an offshore oil or wind turbine platform including structural supports, a blowout preventer, casing, a flow control device, a measurement device, a sensor, a viewport, oil spill remediation equipment, bioremediation equipment, undersea “Christmas trees”, or oil processing equipment, and wherein the polymeric coating layer is formed on a surface of the component that will come in contact with hydrocarbons or other foulants.
